(19) United States
(12) Patent Application Publication
(10) Pub. No.: US 2007/0147259 A1
(43) Pub. Date: Jun. 28, 2007

(54) Synchronous optical network (SONET) demarcation device

(75) Inventor: Barbara E. Smith, San Antonio, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/315,233

(22) Filed: Dec. 23, 2005

(51) Int. Cl. H04J 1/16

(52) U.S. Cl. 370/242

(57) ABSTRACT

A synchronous optical network (SONET) demarcation device can be placed on a customer premises to enable remote testing and trouble shooting of customer premises equipment. The device includes a SONET signal analyzer that extracts SONET data, such as section, line and path overhead. The SONET demarcation device also includes a SONET fault condition, performance statistics, and alarm generator that generates fault conditions, performance statistics, and alarms based upon the extracted SONET data. The device also includes a transmitter that transmits the alarm and/or performance data to a remote site. The SONET demarcation device does not include ring functionality and/or multiplexing functionality, thus being lower in cost than a SONET multiplexer.

### BACKGROUND

1. Field of the Disclosure

The present disclosure relates to networking. More particularly, the present disclosure relates to a SONET demarcation box.

2. Background Information

Currently, SONET services are designed with a SONET multiplexer on the customer premises. The multiplexers on the customer premises demultiplex to a lower rate signal and also enable remote fault and performance monitoring, testing and troubleshooting of the customer's optical circuit on an end-to-end basis. The SONET multiplexers typically have ring functionality.

Placing SONET multiplexer equipment at the customer premises is expensive. Thus, edgeless equipment configurations have been proposed to eliminate the SONET multiplexer from the customer premises. This design, however, eliminates the capability to remotely monitor and test the optical facility at the customer premises. When customer trouble is reported, a technician must be dispatched (i.e., a truck roll) to perform the reporting/testing at the customer premises.

### BRIEF DESCRIPTION OF THE DRAWINGS

FIG. 1 shows an exemplary general computer system that can operate as a SONET demarcation box; and

FIG. 2 shows an exemplary system including a SONET demarcation device, according to an aspect of the present invention.

### DETAILED DESCRIPTION

In view of the foregoing, the present invention, through one or more of its various aspects, embodiments and/or specific features or sub-components, is thus intended to bring out one or more of the advantages as specifically noted below.

In one aspect of the present invention, a synchronous optical network (SONET) demarcation device for placement at a customer premises includes a SONET signal analyzer that extracts SONET data. The device also includes a SONET fault condition, performance statistics, and alarm generator to generate fault conditions, performance statistics, and alarms based upon extracted SONET data. The device further includes a transmitter to transmit the alarm and/or performance data to a remote site. The SONET demarcation device does not include ring functionality in one embodiment. In another embodiment, the SONET demarcation device does not include multiplexing functionality. The SONET demarcation device allows remote fault and performance monitoring and testing of SONET signals terminating at the customer premises.

The SONET data can be section, path, and line overhead. The device can also include a regenerator that regenerates a received SONET signal. The device can provide 1+1 protection switching.

In one embodiment, the device also includes a loop back system that creates a terminal loop back and/or a facility loop back. The SONET signal analyzer can convert a received SONET signal into an electrical signal.

The SONET fault condition, performance statistics, and alarm generator can generate an Alarm Indication Signal (AIS), a Loss of Signal (LOS), a Loss of Frame (LOF), a Loss of Pointer (LOP), a Remote Defection Indication (RDI), a Remote Error Indication (REI), and/or a Remote Fault Indication (RFI). The SONET fault condition, performance statistics, and alarm generator can generate Coding Violations, Errored Seconds, Severely Errored Seconds, and/or Unavailable Seconds based on Bit Error Statistics generated by B1, B2, and B3 bytes.

SONET section, line and path data communications channels can be used to transmit fault conditions and performance statistics to an Add-drop Multiplexer (ADM) in a central office.

A new low cost network element is provided at the customer premises. This new network element, also referred to as a SONET demarcation box, allows remote fault and performance monitoring, testing and trouble shooting without truck rolls, and without having SONET multiplexer equipment at the customer premises.

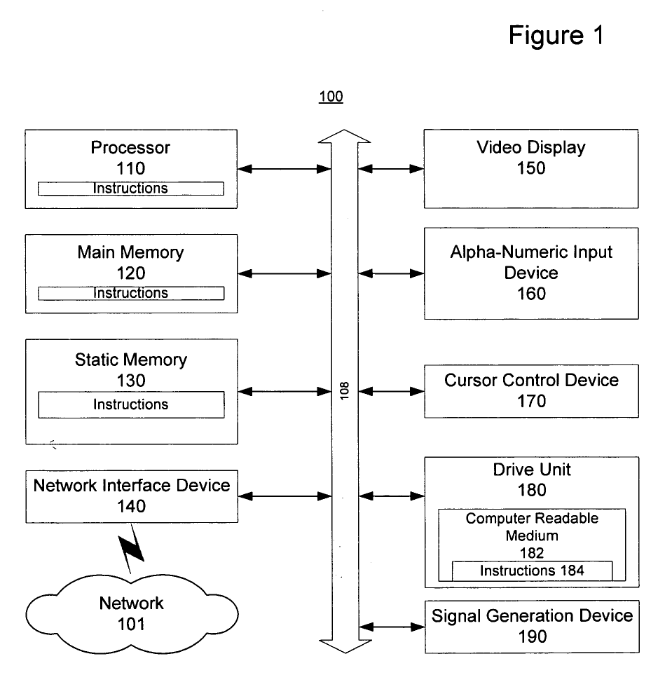

Referring to FIG. 1, a description is now provided of an illustrative embodiment of a general computer system 100, on which the SONET demarcation functionality can be implemented. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

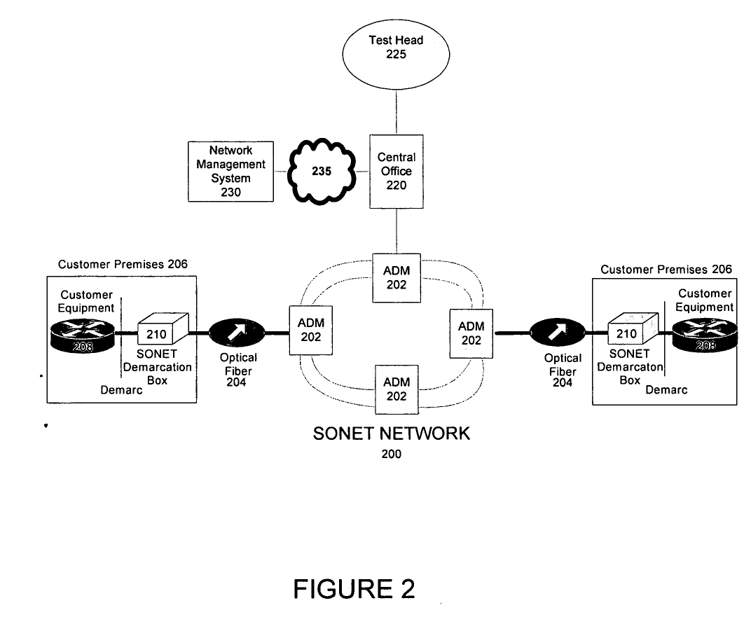

Referring to FIG. 2, a SONET 200 includes multiple add/drop multiplexers (ADMs) 202, and is connected via optical fiber 204 to customer premises 206. Each customer premises 206 includes customer equipment 208 and a SONET demarcation box 210. Although not numbered in FIG. 2, a point of demarcation (demarc) is also located on the customer premises 206.

A central office 220 connects to the SONET 200. A network management system 230 collects fault conditions and performance statistics via a data communications network 235. A test head 225 connects to the central office 220 and performs troubleshooting by inserting test signals and looping the signal back to the test head 225. The test head 225 should also include an optical interface to Add-drop Multiplexer (ADM) 202 in the Central Office 220 for loop backs.

In one embodiment, the SONET demarcation device 210 includes the capability to extract SONET section, line and path overhead for obtaining section, line and path failure and performance statistics. This data is accessed without taking the customer out of service. The device 210 converts the optical signal to an electrical signal, in order to analyze the signal content, and then re-converts the signal back to optical. The device 210 can also regenerate the signal and provide 1+1 protection switching.

In one embodiment, section and line data communications channels are provided to the central office 220 for connection to the network management system 230 via the data communications network 235. Each channel can be used to send control messages from the test head 225 or network management system 230 to the SONET Demarcation Box 210 on the customer premises 206, for example, to perform a terminal loop back and/or a facility loop back. The channels also enable sending of performance monitoring statistics from the device 210 to the Add-drop Multiplexer (ADM) 202 in the central office 220.

The SONET demarcation device 210 can receive section, line and path Loss of signal (LOS), loss of frame (LOF), loss of pointer (LOP) signals, and can generate a Remote Defect Indication (RDI) or Alarm Indication Signal (AIS). For example, if the fiber 204 is cut, the device 210 receives a LOS signal and in response generates a Remote Defect Indication (RDI) for sending back to the ADM 202 in central office 220. In another example, if a degraded signal is received, an alert based upon a threshold is sent. Remote error indications (REI) and Remote Failure Indications (RFI) at synchronous transport signal (STS) and virtual tributary (VT) path layers can also be generated by the SONET demarcation device 210. All of the fault indications are sent in real time.

The device 210 can also periodically send performance monitoring data to the network management system 230. In another embodiment, the performance monitoring data is retrieved from the device 210 by the network management system 230. For example, the data is gathered at least once within a 24 hour period so that registers within the SONET demarcation box 210 can be reset.

In one embodiment, the device 210 can perform parity checks, and generate information, such as B1, B2, and B3 Bit interleaved parity information. The device can also frame on the signal.

The SONET demarcation box 10 is more than a SONET regenerator at least because it contains SONET section, line and path overhead functionality. However, the device 210 will be lower cost than a traditional SONET multiplexer because it does not include terminal multiplexer, Add-drop Multiplexer, Drop and Continue functionality, and/or next generation SONET switch matrix capability. Because the SONET demarcation device 210 is intended for point-to-point protected and unprotected applications, ring functionality is not required. A 1+1 protection can be implemented using a transmit bridge of the signal and tail end selector function.

In one embodiment, the SONET demarcation box 10 can be used for OC-N point to point applications where N is equal to 3, 12, 48, and 192. Likewise, this device 210 can be used for point-to-point “clear channel” transport of a SONET OC-N signal across a wavelength division multiplex (WDM) network.

The SONET demarcation box lowers the cost to provide OC-N point to point transport at any speed by eliminating costly next generation SONET add-drop multiplexers with ring functionality at the customer premises. Also, the SONET demarcation box provides remote testing, fault and performance monitoring and trouble shooting capabilities for OC-N point-to-point transport without the cost of current next generation SONET equipment.

Although the present specification describes components and functions that may be implemented in particular embodiments with reference to particular standards and protocols, the invention is not limited to such standards and protocols. For example, synchronous digital hierarchy (SDH) can be substituted for SONET. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A synchronous optical network (SONET) demarcation device for placement at a customer premises, comprising:
a SONET signal analyzer to extract SONET data;
a SONET fault condition, performance statistics, and alarm generator to generate fault conditions, performance statistics, and alarms based upon extracted SONET data; and
a transmitter to transmit the alarm and/or performance data to a remote site and to allow remote fault and performance monitoring and testing of SONET signals terminating at the customer premises,
wherein the SONET demarcation device does not include ring functionality.

2. The SONET demarcation device of claim 1, in which the SONET data comprises section, path, and line overhead.

3. The SONET demarcation device of claim 2, further comprising a regenerator that regenerates a received SONET signal.

4. The SONET demarcation device of claim 1, in which the device further provides 1+1 protection switching.

5. The SONET demarcation device of claim 1, further comprising a loop back system that creates a terminal loop back.

6. The SONET demarcation device of claim 1, further comprising a loop back system that creates a facility loop back.

7. The SONET demarcation device of claim 2, in which the SONET signal analyzer converts a received SONET signal into an electrical signal.

8. The SONET demarcation device of claim 2, in which the SONET fault condition, performance statistics, and alarm generator generates at least one of an Alarm Indication Signal (AIS), a Loss of Signal (LOS), a Loss of Frame (LOF), a Loss of Pointer (LOP), a Remote Defection Indication (RDI), a Remote Error Indication (REI), and a Remote Fault Indication (RFI).

9. The SONET demarcation device of claim 2, in which the SONET fault condition, performance statistics, and alarm generator generates at least one of Coding Violations, Errored Seconds, Severely Errored Seconds, and Unavailable Seconds based on Bit Error Statistics generated by B1, B2, and B3 bytes.

10. The SONET demarcation device of claim 2, in which SONET section, line and path data communications channels are used to transmit fault conditions and performance statistics to an Add-drop Multiplexer (ADM) in a central office.

11. A synchronous optical network (SONET) demarcation device for placement at a customer premises, comprising:
a SONET signal analyzer to extract SONET data;
a SONET signal generator to generate fault conditions, performance statistics, and alarms based upon extracted SONET data; and
a transmitter to transmit the alarm and/or performance data to a remote site,
wherein the SONET demarcation device does not include multiplexing functionality.

12. The SONET demarcation device of claim 11, in which the SONET data comprises section, path, and line overhead.

13. The SONET demarcation device of claim 12, further comprising a regenerator that regenerates a received SONET signal.

14. The SONET demarcation device of claim 11, further comprising a loop back system that creates a terminal loop back.

15. The SONET demarcation device of claim 11, further comprising a loop back system that creates a facility loop back.

16. The SONET demarcation device of claim 11, in which the device further provides 1+1 protection switching.

17. The SONET demarcation device of claim 12, in which the SONET signal analyzer converts a received SONET signal into an electrical signal.

18. The SONET demarcation device of claim 12, in which the SONET signal generator generates at least one of an Alarm Indication Signal (AIS), a Loss of Signal (LOS), a Loss of Frame (LOF), a Loss of Pointer (LOP), a Remote Defection Indication (RDI), a Remote Error Indication (REI), and a Remote Fault Indication (RFI).

19. The SONET demarcation device of claim 12, in which the SONET signal generator generates at least one of Coding Violations, Errored Seconds, Severely Errored Seconds, and Unavailable Seconds based on Bit Error Statistics generated by B1, B2, and B3 bytes.

20. The SONET demarcation device of claim 12, in which SONET section, line and path data communications channels are used to transmit fault conditions and performance statistics to an Add-drop Multiplexer in a central office.
